(19) United States
(12) Patent Application Publication
(10) Pub. No.: US 2006/0109470 A1
(43) Pub. Date: May 25, 2006

(54) Measuring environmental parameters

(76) Inventor: Randy Dean May, Glendora, CA (US)

Correspondence Address: FISH & RICHARDSON, PC, P.O. BOX 1022, MINNEAPOLIS, MN, 55440-1022, US

(21) Appl. No.: 11/261,745

(22) Filed: Oct. 27, 2005

Related U.S. Application Data
(60) Provisional application No. 60/522,696, filed on Oct. 28, 2004.

(51) Int. Cl. G01N 21/61

(52) U.S. Cl. 356/437

(57) ABSTRACT

Intensity measurements characterizing at least two absorption lines for a molecule of interest within at least one sample of gas may be used to calculate at least one ratio which may be associated with a level of an environmental parameter of interest. Related apparatuses, techniques, systems, computer program products are also described.

### CLAIM OF PRIORITY

This application claims priority from U.S. Pat. App. No. 60/522,696 entitled “System for Measuring Static Air Temperature from an Aircraft,” filed Oct. 28, 2004, the contents of which are hereby fully incorporated by reference.

### TECHNICAL FIELD

The subject matter described herein relates to the measurement of environmental parameters, such as temperature and concentration level, in a variety of testing sites, such as an external surface of an aircraft or other vehicle.

### BACKGROUND

Measurements of environmental parameters such as temperature, humidity, and air quality or composition provide critical components of environmental monitoring. Such measurements are crucial for activities such as air and sea travel, weather forecasting, and various outdoor events. However, conventional environmental monitoring devices do not always provide rapid, accurate, low-cost, and mobile environmental monitoring solutions.

### SUMMARY

In one aspect, intensity measurements (e.g., transmission level, width or profile of absorption line, area under an absorption line, etc.) characterizing at least two absorption lines for a molecule of interest (e.g., CO₂ or O₂, etc.) within at least one sample of gas may be determined. Thereafter, at least one ratio (e.g., area ratio) based on the intensity measurements for the at least two absorption lines may be calculated. This ratio may then be associated with a level of an environmental parameter of interest (e.g., concentration, temperature, etc.).

In those variations, in which the molecule of interest is measured, the light source may emit light at a wavelength in the range of 759 to 768 nm. Such a light source may be a laser that is used, for example, to determine static air temperature.

The subject matter described herein may be utilized to conduct measurements in a variety of settings, such as in a laboratory, within an exhaust stack, on an external surface of an aircraft and the like. For example, a light source operable to emit light at wavelengths associated with the at least two absorption lines may be directed from a first external surface of an aircraft to a reflector mounted on a second external surface of the aircraft. The reflector may be operable to reflect light towards a receiver mounted on a third external surface of the aircraft (which may be adjacent to the first external surface) so that the reflected light is directed to a detector. Electronics and/or software coupled to the detector may then translate the detected signal into a level for the desired environmental parameter (using, for example, predetermined data associating detected levels with the levels of the environmental parameter).

In another interrelated aspect, at least one light source operable to respectively emit light at wavelengths associated with first and second groups of absorption bands that may be collinearly directed from a first external surface of an aircraft to a reflector mounted on a second external surface of the aircraft. The reflector may be operable to reflect light towards a receiver mounted on a third external surface of the aircraft (which may be adjacent to the first surface). The receiver may be positioned to direct the reflected light to first and second detectors. Optionally, the reflector may reflect light directly onto the detectors, thereby obviating the need for a receiver. The detectors may include filters so that only wavelengths associated with one of the first and second groups of absorption bands are detected. The detected information may then be associated with a level of an environmental parameter of interest. The light source may comprise multiple lasers or optionally a tunable laser. In some variations, the intensity measurements are based on two or more absorption lines each having substantially different temperature dependence characteristics.

In another aspect, an apparatus may comprise at least one light source, a reflector, at least one detector, and a processor. The at least one light source may be operable to emit light from a first external surface on an aircraft at wavelengths corresponding to at least two absorption lines. The reflector may be positioned opposite the light source to reflect the emitted light. The at least one detector may be operable to detect the reflected light. A processor coupled to the detector may be operable to calculate at least one area ratio based on the reflected light detected by the detector and to associate the at least one calculated area ratio with a level of an environmental parameter of interest. In some variations, the apparatus may further comprise a receiver to direct the reflected light to the at least one detector.

In still another interrelated aspect, light may be emitted by a light source to characterize a single absorption line of interest for a molecule. The light source may be positioned to emit light from a first external surface of an aircraft to a reflector mounted on a second external surface of the aircraft. The reflector may be operable to reflect light towards a receiver mounted on a third external surface of the aircraft. The receiver may be operable to direct the reflected light to a detector so that a line width for the absorption line may be determined. The line width may be associated with a level of an environmental parameter of interest within a sample of gas disposed between the light source and the reflector. In some variations, pressure outside of the aircraft may be determined and the determined pressure may be used to associate the line width with a level of an environmental parameter of interest.

In yet another interrelated aspect, a first intensity measurement for at least one absorption line for a molecule of interest at a first temperature and a second intensity measurement for the at least one absorption line for the molecule of interest at a second temperature may be simultaneously determined. Such an arrangement may utilize two light sources to conduct the intensity measurements at both temperatures or a single light source which is directed into each sample. Thereafter, a ratio of the first intensity measurement and the second intensity measurement may be calculated. This ratio may then be associated with a level of an environmental parameter of interest.

In another interrelated aspect, an apparatus may comprise a light source, a reflector, a receiver, and a detector. The light source may be mounted on a first external surface of an aircraft and operable to emit light corresponding to at least one absorption line for a molecule of interest and directed towards a second surface of the aircraft. The reflector may be mounted on the second external surface of the aircraft and operable to receive at least a portion of the emitted light, the emitted light passing through air outside of a boundary layer associated the aircraft. The receiver may be mounted on a third external surface (which may be adjacent to the first surface) of the aircraft and operable to receive light reflected from the reflector. The detector may be operable to receive light directed from the receiver. The apparatus may also, in some variations, comprise the aircraft.

### DESCRIPTION OF DRAWINGS

FIG. 1 is a process flow diagram illustrating a method of determining a level of an environmental parameter of interest within a sample of gas based on multiple absorption lines for a molecule of interest;

FIG. 2 is a process flow diagram illustrating a method of determining a level of an environmental parameter of interest within a sample of gas based on a single absorption line for a molecule of interest that is interrelated to the method illustrated in FIG. 1;

FIG. 3 is a process flow diagram illustrating a method of determining a level of an environmental parameter of interest within a sample of gas based on intensity measurements of at least one absorption line at multiple temperatures that is interrelated to the methods illustrated in FIGS. 1 and 2;

FIG. 4 is a schematic diagram of an apparatus to determine a level of an environmental parameter of interest associated within a sample of gas;

FIG. 5A is a top view of an aircraft having devices to determine a level of an environmental parameter of interest associated mounted to an external surface of an aircraft within a sample of gas;

FIG. 5B is an expanded view of sectional 510 of the apparatus of FIG. 5 illustrating the devices of determining the level of the environmental parameter of interest;

FIG. 6 is a graph showing sample transmission levels of an O₂ doublet having wavelengths near 762.6 nm at two temperatures 190 K and 313 K;

FIG. 7 is a graph showing sample transmission levels of an O₂ doublet having wavelengths near 765.6 nm;

FIG. 8 is a graph illustrating a ratio of areas under at least two absorption lines in relation to temperature; and

FIG. 9 is a graph illustrating various absorption lines for a molecule of interest at two different temperatures.

### DETAILED DESCRIPTION

While the following is primarily described in connection with the measurement of temperature, it will be appreciated that other environmental parameters of interest may be measured using the subject matter described herein such as composition of air. Moreover, it will be appreciated that the measurements described herein may be obtained using a variety of sampling techniques, including Herriott cells, devices situated within exhaust stacks, and the like. Additionally, absorption lines for molecules other than O₂ and CO₂ may be utilized depending on the desired environmental parameter of interest.

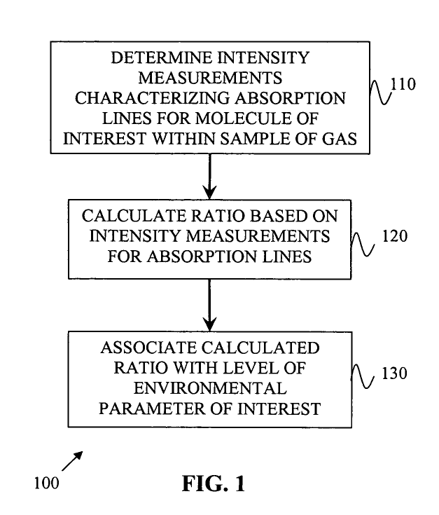

FIG. 1 is a process flow diagram that illustrates a method 100, in which, at 110, intensity measurements characterizing at least two absorption lines for a molecule of interest within at least one sample of gas are determined (from, for example, an exterior surface of a mobile platform). From these intensity measurements, at 120, at least one ratio based on the intensity measurements for the at least two absorption lines is calculated. Thereafter, at 130, the at least one calculated ratio is associated with a level of an environmental parameter of interest.

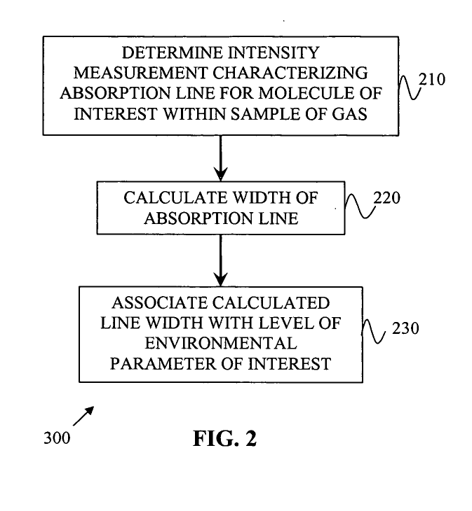

FIG. 2 is a process flow diagram that illustrates a method 200 (that is interrelated to the method of FIG. 1), in which, at 210, light may be emitted by a light source so as to characterize at least one single absorption line associated with a molecule of interest. Subsequently, at 220, the width of the absorption line may be calculated. This calculated line width is associated, at 230, with a level of an environmental parameter of interest.

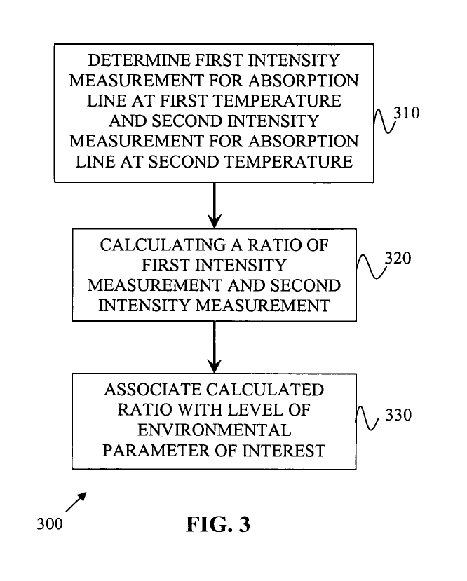

FIG. 3 is a process flow diagram that illustrates a method 300 (that is interrelated to the methods of FIGS. 1 and 2), in which at 310, intensity measurements for an absorption line for a molecule of interest at a first temperature and at a second temperature are determined. Thereafter, at 320, a ratio of the first intensity measurement and the second intensity measurement is calculated. This calculated ratio, is associated, at 330, with a level of an environmental parameter of interest.

In some variations, each of the methods described in connection with FIGS. 1-3 may be acquire the intensity measurements from a device mounted to an exterior surface of an aircraft or other moving object in which one or more light sources emit light outside of a boundary layer of the aircraft and at least one detector mounted on the exterior surface of the aircraft detects the emitted light.

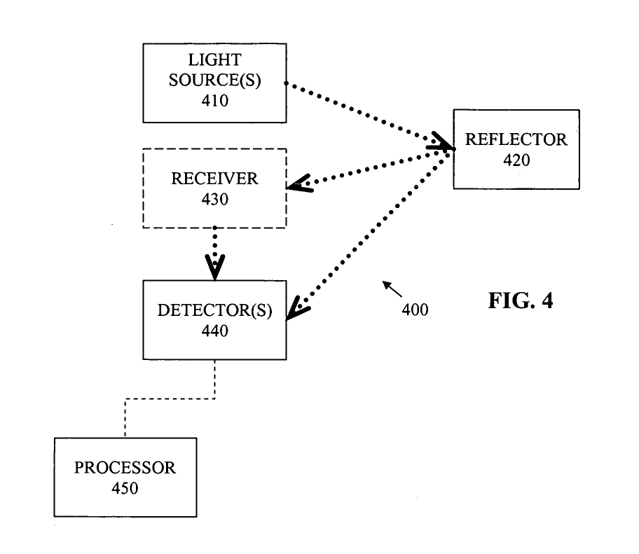

FIG. 4 illustrates an apparatus 400 comprising at least one light source 410, a reflector 420, at least one detector 440, and optionally a receiver 430. The light source(s) 410 may be operable to emit light so that at least one absorption line for a molecule of interest may be characterized (e.g., a profile of the at least one absorption line may be obtained). The light source 410 is positioned so that light passes through a sample of gas, such as air, to the reflector 420 which in turn reflects the light to, in one variation, the receiver 430 which in turn directs the light to the detector 440, or directly to the detector 440 in another variation.

The following provides optional variations which may be incorporated singly or in combination depending on the desired configuration.

The temperature measurements described herein utilize temperature-dependent properties of molecular gas absorption lines to derive the static temperature of a sample of gas (e.g., a temperature that does not take into account fluctuations due to velocity of the aircraft of other mobile platform). In some variations, the sample of gas is air through which an object, such as an aircraft, is moving. Spectroscopic measurements at appropriate wavelengths using a narrow-width light source such as a high-resolution laser source provide the raw data. Analysis of such data allow the static air temperature to be derived accurately, in real time.

Molecules that comprise the air present in the Earth's atmosphere absorb light at certain wavelengths depending on the structure of the molecule. The distinct and unique pattern of light absorption (versus wavelength) of each molecule is called the molecular spectrum. Most molecules absorb light over a wide range of wavelengths extending from the ultraviolet to the infrared wavelength regions, and beyond. The intensity (or amount) of absorption also varies widely between molecules, and has a temperature dependence that can be very weak or very strong depending on the exact wavelength. This temperature dependence of the absorption can be exploited to derive static air temperature from a spectroscopic measurement.

Air in the Earth's atmosphere consists primarily of oxygen (O₂) and nitrogen (N₂) at approximate percentages (by volume) of 21% and 78%, respectively. Smaller amounts of other gases are also present, including water (H₂O) and carbon dioxide (CO₂), as well as trace levels of hundreds of other gases. For implementation of those variations described herein in which static air temperature external to an aircraft is determined, O₂ may be utilized due to its relatively constant concentration with altitude, and the presence of an absorption band at a convenient wavelength (759-768 nm) where single-frequency tunable laser sources are readily available at relatively low cost. With longer wavelength light sources, other gases (particularly CO₂) are also suitable for measurements such as static air temperature. In aircraft variations, the main requirement is that the molecule contain absorption features at wavelengths where single-frequency, tunable lasers are available, and have little variation in concentration over the altitudes used by commercial aircraft (0-40,000 feet).

Using the O₂ spectrum as an example, and a single-frequency tunable laser operating in the 759-768 nm region where the O₂ A-X electronic band occurs, a static air temperature measurement can be made using any one, or a combination of, the following three approaches:

In one variation, using a method such as that illustrated in FIG. 1, separate O₂ lines (or groups of lines) may be measured at the same temperature. With this arrangement, precise measurement of the ratios of the areas (or intensities) of two or more O₂ lines that have different temperature dependent characteristics are used to determine a level of an environment parameter of interest, such as static air temperature.

Two separate O₂ spectral lines (or groups of lines) may be measured along a common optical path, such as a path outside an aircraft. The spectral lines may be chosen to have different temperature dependencies for their intensities. In this case, it is possible to derive temperature from either the ratio of the areas under the spectral lines, or the ratio of their absorption intensities. Using areas rather than intensities eliminates dependence on molecular line widths, aircraft altitude (i.e., pressure) or the instrumental resolution, provided that the instrumental resolution is such that there is no overlap of adjacent spectral lines within the O₂ band (which is the case when using a single-frequency tunable laser). Moreover, with this approach, there is no need to make any adjustments based on optical path because the laser beam (or beams if two collinear but separate lasers are utilized, each emitting light corresponding to different absorption lines) travels the same optical path for both lines or groups of lines, the measurement is independent of the optical path length. For measurements of O₂ absorption lines at or near 760 nm, relative intensity measurements may be associated with temperature, using, for example, “Experimental Line Parameters of the Oxygen A-Band at 760 nm”, L. R. Brown and C. Plymate, J. Molecular Spectroscopy, Vol. 199, pages 166-179, (2000), the contents of which are hereby incorporated by reference.

In some variations, a precise laser wavelength scale may be incorporated. For example, an etalon with a known, fixed, free spectral range may be utilized to provide relative wavelength measurements. Moreover, a fixed etalon may be able to provide an absolute wavelength when associated with a known absorption line. While ratios based on transmission levels is not independent of pressure, such measurements requires knowledge of associated pressure broadening coefficients. However, using transmission levels eliminates the need for an accurate laser wavelength scale and can provide a higher signal-to-noise ratio in the raw measurement data because harmonic detection schemes can be employed.

In another aspect, using for example, the method illustrated in FIG. 2., precise measurement of an absolute spectral line width (in wavelength units) of a single O₂ absorption line (also referred to as a spectral line) may be used to provide static air temperature (as opposed to arrangements in which multiple intensity measurements are compared). Three factors may need to be taken into account when determine absolute spectral line width, namely Doppler width, pressure broadened width, and any instrumental distortion.

The Doppler width is proportional to the square root of temperature. This width is a fundamental property of the spectral line and can be calculated to high accuracy if the temperature and molecular weight of the absorbing gas is known. It is independent of pressure (i.e., aircraft altitude).

The pressure broadened width (also known as Lorentizian, or collisionally broadened, width) is proportional to temperature raised to an exponential power (which is typically 0.5 to 1.0, with 0.7 being average for most molecules). This width is also a fundamental property of the spectral line and varies linearly with pressure to first approximation. It is a function of the broadening gas composition because each component gas will broaden the absorbing gas differently. Pressure broadening coefficients may be measured in the laboratory as they are difficult to calculate accurately from first principles.

Additionally, instrumental distortion due to a finite instrument bandwidth, or resolving power may affect absolute spectral line width. This effect may be minimized by using a very narrow line width laser. However, in some cases, instrumental distortion may need to be characterized in advance so that any intensity measurements may be accordingly adjusted.

In order to derive absolute temperature from the measurement of the width of a spectral line it is necessary to know, to high accuracy, the temperature dependencies of both the Doppler width and the pressure broadened width. The Doppler width's dependence on temperature is known precisely and can be accurately calculated directly from the molecular weight of the molecule. Pressure broadening coefficients can be measured in the laboratory, but the absolute accuracy required in the laboratory values is of the order of one part in one thousand. In addition, the raw measurement of the O₂ spectral line width must be made with a very high signal-to-noise ratio (SNR), also of the order of one part in one thousand, making this approach dependent on an appropriate laser source and precise laboratory measurements of the pressure broadening coefficients. A precise, real-time static pressure measurement may also be required, along with a precise measurement of the laser wavelength across the recorded spectrum which can be obtained using an appropriate etalon or other wavelength reference.

In another aspect, a method such as that illustrated in FIG. 3 may be utilized in which the same O₂ line (or groups of lines) may be analyzed at different temperatures by, for example, precisely measuring ratios of the area (or width, transmission level, etc.) of the same O₂ line, or same group of lines, at different temperatures. With this arrangement, a separate reference cell containing air that is brought in from the outside (using, for example, a scoop mounted to an external surface of an aircraft) and heated to a precise temperature may be utilized (using, for example, a resistive heating element).

Instead of using two separate O₂ lines or line groups, a single line or line group may be utilized. The laser source may be split into two beams, one of which samples the outside static air and one of which is directed to the thermostatted reference gas cell. The laser scans the same O₂ line or group of lines in both paths, and their area ratio or intensity ratio may be measured to derive absolute temperature. With this variation, the same spectral lines may be used in both measurement regions (outside air and reference cell) thereby simplifying the analysis, and a single laser can be used for the measurement.

For the methods in each of FIGS. 1-3, a light source 410 (e.g., a narrow width laser, LED, etc.) may be directed from an origin point to a detector 440 at a terminal point to detect the laser light that is transmitted from the origin point (which need not necessarily be the light source 410). Alternatively, a reflector 420 may be placed at the terminal point to reflect laser light back to near the origin point where a receiver 430 collects the returned light from the laser 410 and directs it to a detector 440. A processor 450 (e.g., microcontroller, data acquisition unit, etc.) may be coupled to the detector 440 to associate the detected intensity with a level of an environmental parameter of interest, such as temperature, concentration, etc.

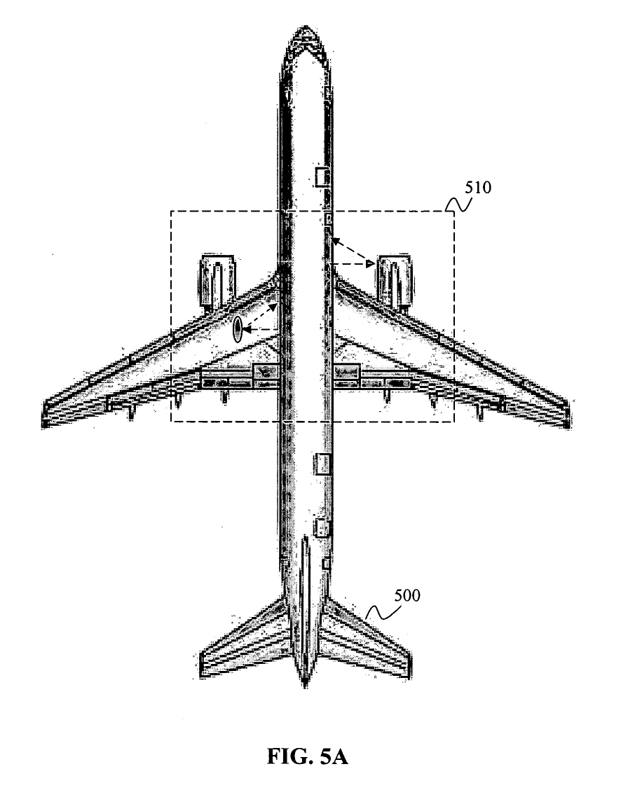

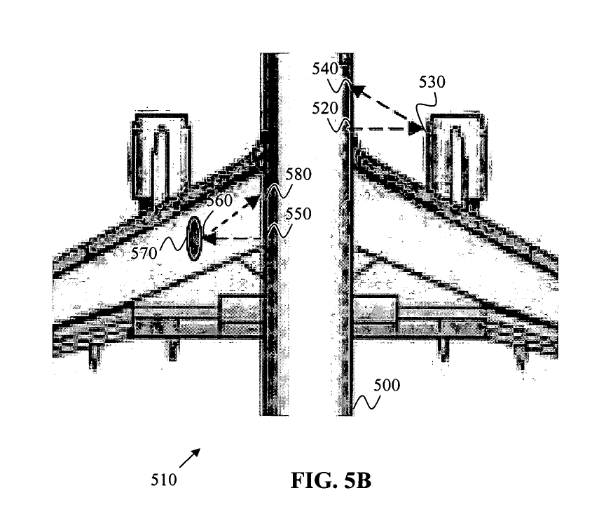

FIG. 5A is a top view of an aircraft 500. FIG. 5B is an expanded view of section 510 of FIG. 5A. With this arrangement, one or more apparatuses, such as that illustrated in FIG. 4 may, for example, be mounted to an upper exterior surface of the aircraft fuselage, tailward of the crew cabin windows. For example, a light source 520 may emit light from a central fuselage of the aircraft 510 to an engine housing which has a reflector 530 mounted thereon. The reflector 530 reflects light to either a detector 540 or a receiver which in turn directs the light to a detector. With this configuration, the emitted light is directed through a volume of air that is substantially out of the aircraft boundary layer. In addition, or in the alternative, a light source 550 may emit light from a central fuselage of the aircraft to a protrusion 570, such as a fin mounted on a lower surface of a wing of the aircraft. The protrusion 570 may have a reflector or reflecting surface 560 which reflects the emitted light to a detector or receiver coupled to a detector 580. Depending on the aircraft type, there are a multitude of possible configurations that can be employed to transmit the laser light through a static air path.

The reflector 520, 560 may be reflective paint or a retroreflector consisting of an array of tiny corner-cube reflectors. A retroreflector reflects light directly back to the source so that movement of the aircraft wing in the vertical direction during flight does not affect the position of the returned beam at the receiver. The receiver 540, 580 may be a small telescope or a simple lens which collects the returned light and directs it to a detector.

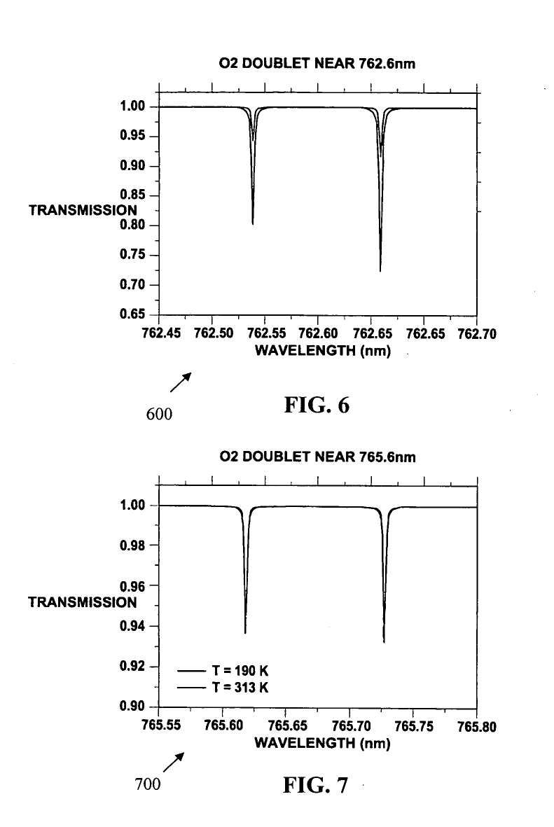

Measurement of the O₂ spectrum may be carried out by using a light source, such as an external cavity tunable laser that covers substantially the entire O₂ A-X band. For example, swept frequency lasers such as those produced by Iolon, San Jose, Calif. may be used for this application. Such a tunable light source allows for enhanced statistics by generating the area ratios of a plurality of pairs of spectral lines to derive a more accurate static temperature. However, in some variations, two separate lasers (e.g., DFB or VCSEL lasers), may be used so that each laser is configured to tune across one selected O₂ doublet, such as the doublets shown in FIGS. 6 and 7. While, two separate lasers may, in some cases, provide a lower cost than a single external cavity laser capable of scanning the entire O₂ A-X band, such a tunable laser may provide a more accurate temperature measurement.

In those variations utilizing multiple lasers, the separate laser beams collinearly aligned in space may be combined in a 2×1 fiber combiner and directed to a gradient index (GRIN) lens attached to the end of the fiber. With both the single and dual laser approaches, such configurations represents the transmitter portion of the system and creates a directed beam of light consisting of the single laser output, or the combined energy from two separate laser sources collinearly aligned in space. Two lasers may scan two separate O₂ “doublets” (a pair of closely-spaced individual spectral lines) such as those in FIGS. 6 and 7. To make a single static air temperature measurement, each laser is scanned over its respective O₂ doublet at a high rate that is typically several hundred Hertz.

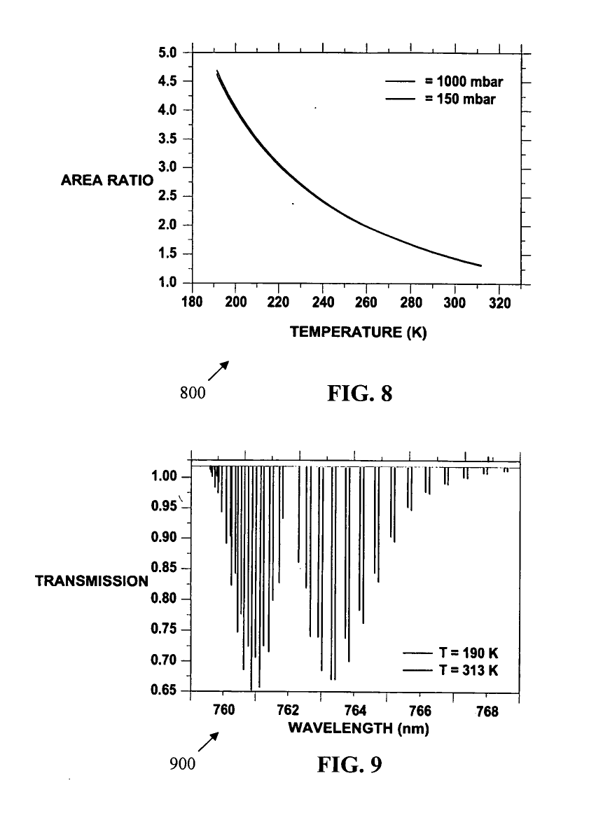

Additionally, with those variations in which multiple absorption lines/doublets are analyzes, the signal received by the receiver may be split into two portions and directed to two different detectors equipped with filters. The filters may be centered on each respective O₂ doublet in order to separate the spectra from the two lasers in wavelength. For example, a first detector may record the spectrum of the doublet illustrated in FIG. 6, and a second detector may record the spectrum of the doublet illustrated in FIG. 7. Software may then perform a baseline fit and normalization routine to convert the raw spectra into transmission spectra such as that shown in FIG. 9. Finally, a nonlinear least squares fit may be performed to obtain the areas under the spectral lines within each O₂ doublet. The ratio of the areas of each doublet relates to a specific absolute temperature as shown in FIGS. 6 and 7. As illustrated in FIG. 8, the relationship between the area ratio and temperature is not linear, being much more sensitive at lower temperatures than at higher temperatures. As commercial aircraft cruise altitudes are typically >25,000 feet, static air temperatures are often well below −30° C. The area ratio is most sensitive to temperature in this range, and below.

FIGS. 6 and 7 show two different oxygen molecule doublets (closely spaced pairs of absorption lines) and their dependence on temperature. The detailed characteristics of the O₂ transmission spectrum have a strong dependence on temperature as well as pressure. FIG. 6 shows a doublet that has a very strong dependence on temperature; FIG. 7 show a doublet that has a much weaker dependence on temperature. The various spectral lines absorb at different levels due to differences in the population of O₂ molecules in the lower energy levels of the transitions. The area under the spectral lines is not a function of pressure, which is an important detail for the proposed measurement technique. To measure temperature, the integrated area under two separate oxygen molecule doublets is measured from spectra such as those shown in FIGS. 6 and 7.

The accuracy of the calculated area ratios in the derived temperature will vary with temperature for the same measurement signal-to-noise ratio (SNR). The derivative (dA/dT) of the curves from FIG. 6 can be used to determine SNR required for a given temperature measurement accuracy. Using −50° C. as an example, the derivative value is −0.035 at this temperature for the 150 mbar curve, and the value of the area ratio itself is 2.88. Therefore, a measurement SNR of 2.88/0.035=82 is required for a temperature error of +1° C. To obtain +0.2° C. temperature error, the raw measurement SNR would have to be five times higher.

Such SNR values may be obtained using laser sources and appropriate signal processing because the laser power level is typically many orders of magnitude (higher than the detector noise equivalent power (NEP)). Other effects such as interference fringes in the spectra, and turbulence induced noise due to beam jitter, will limit the measurement SNR in a real system and may need to be taken into account.

Various implementations and portions of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

It is claimed:

1. A method comprising:
determining intensity measurements from an exterior surface of a mobile platform characterizing at least two absorption lines for a molecule of interest within at least one sample of gas;
calculating at least one ratio based on the intensity measurements for the at least two absorption lines; and
associating the at least one calculated ratio with a level of an environmental parameter of interest.

2. A method as in claim 1, wherein the determining comprises: recording a profile for each of the at least two absorption lines.

3. A method as in claim 1, wherein the intensity measurements are based on areas under the at least two absorption lines.

4. A method as in claim 1, wherein the intensity measurements are based on widths of the at least two absorption line.

5. A method as in claim 1, wherein the molecule of interest is CO₂ or O₂.

6. A method as in claim 5, wherein the environmental parameter of interest is temperature.

7. A method as in claim 1, wherein the molecule of interest is O₂ and the light source emits light at a wavelength in the range of 759 to 768 nm.

8. A method as in claim 1, wherein the light source is a laser.

9. A method as in claim 1, wherein the mobile platform is an aircraft; and
wherein the determining comprises:
directing a light source operable to emit light at wavelengths associated with the at least two absorption lines from a first external surface of the aircraft to a reflector mounted on a second external surface of the aircraft, the reflector reflecting light towards a receiver mounted on a third external surface of the aircraft, the receiver directing the reflected light to a detector; and
detecting the light directed to the detector.

10. A method as in claim 1, wherein the mobile platform is an aircraft; and
wherein the determining comprises:
directing a first light source operable to emit light at wavelengths associated with a first of the at least two groups of absorption bands from a first external surface of the aircraft to a reflector mounted on a second external surface of the aircraft, the reflector reflecting light towards a receiver mounted on a third external surface of the aircraft, the receiver directing the reflected light to a first detector;
directing a second light source operable to emit light at wavelengths associated with a second of the at least two groups of absorption bands from the first external surface of the aircraft to the reflector mounted on the second external surface of the aircraft, the reflector reflecting light towards the receiver mounted on the third external surface of the aircraft, the receiver directing the reflected light to a second detector; and
detecting the light directed to the first detector; and
detecting the light directed to the second detector.

11. A method as in claim 1, wherein at least one intensity measurement is based on two or more absorption lines each having substantially different temperature dependence characteristics.

12. A method as in claim 1, further comprising: emitting light by at least two light sources at wavelengths corresponding to the at least two absorption lines.

13. A method as in claim 1, further comprising: tuning a single light source to emit light at wavelengths corresponding to the at least two absorption lines.

14. An apparatus comprising:
at least one light source emitting light from a first external surface on an aircraft having a wavelength corresponding to at least two absorption lines;
a reflector positioned opposite the light source to reflect the emitted light;
at least one detector to detect the reflected light; and
a processor to calculate at least one ratio based on the reflected light detected by the detector and to associate the at least one calculated ratio with a level of an environmental parameter of interest.

15. An apparatus as in claim 11, further comprising: a receiver to direct the reflected light to the at least one detector.

16. A method comprising:
emitting light by a light source to characterize a single absorption line of interest for a molecule, the light source emitting light from a first external surface of an aircraft to a reflector mounted on a second external surface of the aircraft, the reflector reflecting light towards a receiver mounted on a third external surface of the aircraft, the receiver directing the reflected light to a detector;
detecting the light directed to the detector;
determining a line width for the absorption line; and
associating the line width with a level of an environmental parameter of interest within a sample of gas disposed between the light source and the reflector.

17. A method as in claim 16, further comprising determining pressure outside of the aircraft, and wherein the associating comprises: associating the line width with a level of an environmental parameter of interest based on the determined pressure.

18. A method comprising:
determining a first intensity measurement for at least one absorption line for a molecule of interest at a first temperature and a second intensity measurement for the at least one absorption line for the molecule of interest at a second temperature;
calculating a ratio of the first intensity measurement and the second intensity measurement; and
associating the calculated ratio with a level of an environmental parameter of interest.

19. A computer-program product, embodied on computer-readable material, the computer-program product including executable instructions that cause a computer system to conduct one or more of operations comprising:
determining intensity measurements characterizing at least two absorption lines for a molecule of interest within at least one sample of gas;
calculating at least one ratio based on the intensity measurements for the at least two absorption lines; and
associating the at least one calculated ratio with a level of an environmental parameter of interest.

20. An apparatus comprising:
a light source mounted on a first external surface of an aircraft to emit light corresponding to at least one absorption line for a molecule of interest and directed towards a second surface of the aircraft;
a reflector mounted on the second external surface of the aircraft to receive at least a portion of the emitted light, the emitted light passing through air outside of a boundary layer associated the aircraft;
a receiver mounted on a third external surface of the aircraft to receive light reflected from the reflector; and
a detector to receive light directed from the receiver.
